(19) United States
(12) Patent Application Publication
(10) Pub. No.: US 2026/0350350 A1
(43) Pub. Date: Nov. 5, 2026

(54) ENHANCED TRANSFORMER BASED NEURAL NETWORK ARCHITECTURE WITH ADAPTIVE WEIGHT OPTIMIZATION AND LSTM COMPONENTS

(71) Applicant: NOLA AI, Inc., New Orleans, LA (US)

(72) Inventors: Correy Allen Kowall, New Orleans, LA (US); Robbie Veghlen, New Orleans, LA (US); Sabelo Jupiter, New Orleans, LA (US); Leo Dupuy, New Orleans, LA (US); Nivedita Sivakumar, Richardson, TX (US); Zachary Christiansen, New Orleans, LA (US)

(21) Appl. No.: 19/667,600

(22) Filed: May 4, 2026

Related U.S. Application Data
(60) Provisional application No. 63/799,651, filed on May 4, 2025.

(51) Int. Cl. G06N 3/0442; G06N 3/0499

(52) U.S. Cl. CPC G06N 3/0442; G06N 3/0499

(57) ABSTRACT

The present invention discloses a transformer-based neural network architecture including a modified linear transformation layer configured to update weights using a variance-based learning rule during training. The variance-based learning rule is combined with gradient-based updates derived from a loss function to bias weight representations toward higher-variance feature directions. The architecture further includes long short-term memory (LSTM) processing applied within a subset of decoder layers to capture sequential dependencies in input data. The combination of variance-based weight updates and selective LSTM integration provides improved feature representation and sequential processing within transformer-based models.

### REFERENCE TO RELATED APPLICATIONS

This application claims priority to U.S. Provisional Application No. 63/799,651, filed May 4, 2025, the specification of which is hereby incorporated by reference in their entirety.

### BACKGROUND OF THE INVENTION

### Field of the Art

The disclosure relates to the field of artificial intelligence and machine learning systems, and more particularly to the field of transformer-based neural network architecture used in natural language processing, time-series analysis, and other sequence modeling tasks.

### Discussion of the State of the Art

Transformer-based neural network architecture has emerged as the dominant paradigm for a wide range of artificial intelligence applications, particularly in natural language processing, computer vision, and time-series analysis. These models rely primarily on self-attention mechanisms to process input data in parallel, allowing them to capture long-range dependencies more effectively than their recurrent neural network predecessors. While transformers have demonstrated remarkable capabilities across numerous tasks, they continue to face significant limitations that impact their efficiency, learning capabilities, and generalization performance.

Current transformer models struggle with efficient feature extraction, often failing to properly identify and focus on the most significant patterns in input data. This inefficiency leads to suboptimal representation learning and unnecessary computational overhead. The self-attention mechanism, while powerful for modeling relationships between distant elements, lacks the inherent sequential bias that makes recurrent models particularly effective for capturing fine-grained temporal patterns and local dependencies. This results in transformers struggling with tasks requiring precise understanding of sequential information despite their strong performance on long-range dependency modeling.

Additionally, transformer models may frequently encounter issues with weight instability during training, including exploding or vanishing gradients, particularly when dealing with varied or limited datasets. Their tendency to overfit, especially on smaller datasets, compounds this problem as models may capture noise rather than meaningful patterns. The computational demands of self-attention mechanisms grow quadratically with sequence length, creating significant efficiency challenges that limit practical applications, especially in resource-constrained environments.

Furthermore, standard transformer models typically lack adaptive mechanisms to focus their learning on the most important features or principal components of the input data. This inflexibility in learning focus contributes to inefficient parameter utilization and can impact model performance, particularly in domains with high feature dimensionality or sparse informative signals. When faced with shifts in data distribution over time, standard transformers often struggle to maintain robust performance, as they lack effective mechanisms for dynamically adjusting their internal representations to accommodate such changes.

Hence, there is need for architectural innovation that can enhance the model's ability to identify key patterns in data while maintaining computational efficiency, improve sequential understanding without sacrificing parallelization benefits, and increase stability and generalization capabilities across varied data conditions.

### SUMMARY OF THE INVENTION

Accordingly, the present disclosure describes a transformer-based neural network architecture configured to process sequential data using a plurality of decoder layers including self-attention and feed-forward operations. In some embodiments, at least one linear transformation within a decoder layer is replaced with a modified linear transformation layer configured to update weights during training using a variance-based learning rule based on input activations and corresponding layer outputs. The variance-based learning rule may be combined with gradient-based updates derived from a loss function, enabling hybrid learning that emphasizes higher-variance feature representations while maintaining compatibility with standard optimization techniques.

In some embodiments, long short-term memory (LSTM) processing is selectively applied within a subset of decoder layers to capture sequential dependencies in the input data. The LSTM processing may be applied in conjunction with self-attention operations to provide both contextual and sequential modeling capabilities within the transformer architecture.

The combination of variance-based weight updates and selective LSTM integration provides improved feature representation and enhanced sequential processing within transformer-based neural networks.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is a block diagram illustrating an exemplary hardware architecture of a computing device used in an embodiment of the invention;

FIG. 2 is a block diagram illustrating an exemplary logical architecture for a client device, according to an embodiment of the invention;

FIG. 3 is a block diagram showing an exemplary architectural arrangement of clients, servers, and external services, according to an embodiment of the invention;

FIG. 4 is another block diagram illustrating an exemplary hardware architecture of a computing device used in various embodiments of the invention;

FIG. 5 is an example block diagram of transformer architecture, in accordance with an embodiment of the invention;

FIG. 6A is an example block diagram of an enhanced transformer model, in accordance with an embodiment of the invention;

FIG. 6B is a flowchart depicting the initialization process for the enhanced layers in the transformer model, in accordance with an embodiment of the invention;

FIG. 7 is a flowchart depicting a method for generating principal components of the input data, in accordance with an embodiment of the invention;

FIG. 8A is a flowchart depicting the processing of inputs through the LSTM enhanced transformer layer, in accordance with an embodiment of the invention; and

FIG. 8B is a side-by-side comparison of the standard transformer layer architecture and the LSTM-enhanced version, in accordance with an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of the processes described may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Hardware Architecture

Generally, the techniques disclosed herein may be implemented on hardware or a combination of software and hardware. For example, they may be implemented in an operating system kernel, in a separate user process, in a library package bound into network applications, on a specially constructed machine, on an application-specific integrated circuit (ASIC), or on a network interface card.

Software/hardware hybrid implementations of at least some of the embodiments disclosed herein may be implemented on a programmable network-resident machine (which should be understood to include intermittently connected network-aware machines) selectively activated or reconfigured by a computer program stored in memory. Such network devices may have multiple network interfaces that may be configured or designed to utilize different types of network communication protocols. A general architecture for some of these machines may be described herein in order to illustrate one or more exemplary means by which a given unit of functionality may be implemented. According to specific embodiments, at least some of the features or functionalities of the various embodiments disclosed herein may be implemented on one or more general-purpose computers associated with one or more networks, such as for example an end-user computer system, a client computer, a network server or other server system, a mobile computing device (e.g., tablet computing device, mobile phone, smartphone, laptop, or other appropriate computing device), a consumer electronic device, a music player, or any other suitable electronic device, router, switch, or other suitable device, or any combination thereof. In at least some embodiments, at least some of the features or functionalities of the various embodiments disclosed herein may be implemented in one or more virtualized computing environments (e.g., network computing clouds, virtual machines hosted on one or more physical computing machines, or other appropriate virtual environments).

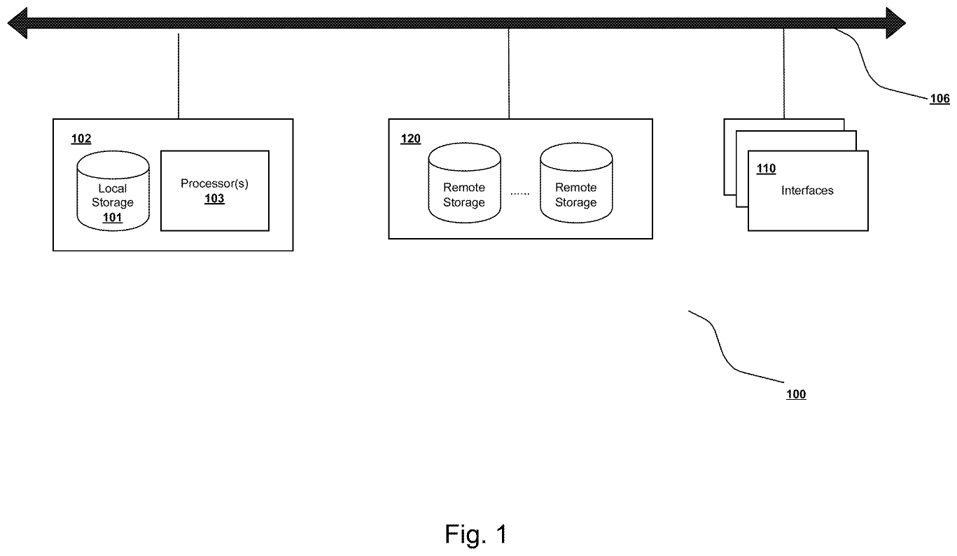

Referring now to FIG. 1, there is shown a block diagram depicting an exemplary computing device 100 suitable for implementing at least a portion of the features or functionalities disclosed herein. Computing device 100 may be, for example, any one of the computing machines listed in the previous paragraph, or indeed any other electronic device capable of executing software-or hardware-based instructions according to one or more programs stored in memory. Computing device 100 may be adapted to communicate with a plurality of other computing devices, such as clients or servers, over communications networks such as a wide area network a metropolitan area network, a local area network, a wireless network, the Internet, or any other network, using known protocols for such communication, whether wireless or wired.

In one embodiment, computing device 100 includes one or more central processing units (CPU) 102, one or more interfaces 110, and one or more buses 106 (such as a peripheral component interconnect (PCI) bus). When acting under the control of appropriate software or firmware, CPU 102 may be responsible for implementing specific functions associated with the functions of a specifically configured computing device or machine. For example, in at least one embodiment, a computing device 100 may be configured or designed to function as a server system utilizing CPU 102, local memory 101 and/or remote memory 120, and interface(s) 110. In at least one embodiment, CPU 102 may be caused to perform one or more of the several types of functions and/or operations under the control of software modules or components, which for example, may include an operating system and any appropriate applications software, drivers, and the like.

CPU 102 may include one or more processors 103 such as, for example, a processor from one of the Intel, ARM, Qualcomm, and AMD families of microprocessors. In some embodiments, processors 103 may include specially designed hardware such as application-specific integrated circuits (ASICs), electrically erasable programmable read-only memories (EEPROMs), field-programmable gate arrays (FPGAs), and so forth, for controlling operations of computing device 100. In a specific embodiment, a local memory 101 (such as non-volatile random-access memory (RAM) and/or read-only memory (ROM), including for example one or more levels of cached memory) may also form part of CPU 102. However, there are many different ways in which memory may be coupled to system 100. Memory 101 may be used for a variety of purposes such as, for example, caching and/or storing data, programming instructions, and the like. It should be further appreciated that CPU 102 may be one of a variety of system-on-a-chip (SOC) type hardware that may include additional hardware such as memory or graphics processing chips, such as a Qualcomm SNAPDRAGON™ or Samsung EXYNOS™ CPU as are becoming increasingly common in the art, such as for use in mobile devices or integrated devices.

As used herein, the term “processor” is not limited merely to those integrated circuits referred to in the art as a processor, a mobile processor, or a microprocessor, but broadly refers to a microcontroller, a microcomputer, a programmable logic controller, an application-specific integrated circuit, and any other programmable circuit.

In one embodiment, interfaces 110 are provided as network interface cards (NICs). Generally, NICs control the sending and receiving of data packets over a computer network; other types of interfaces 110 may for example support other peripherals used with computing device 100. Among the interfaces that may be provided are Ethernet interfaces, frame relay interfaces, cable interfaces, DSL interfaces, token ring interfaces, graphics interfaces, and the like. In addition, various types of interfaces may be provided such as, for example, universal serial bus (USB), Serial, Ethernet, FIREWIRE™, THUNDERBOLT™, PCI, parallel, radio frequency (RF), BLUETOOTH™, near-field communications (e.g., using near-field magnetics), 802.11 (Wi-Fi), frame relay, TCP/IP, ISDN, fast Ethernet interfaces, Gigabit Ethernet interfaces, Serial ATA (SATA) or external SATA (ESATA) interfaces, high-definition multimedia interface (HDMI), digital visual interface (DVI), analog or digital audio interfaces, asynchronous transfer mode (ATM) interfaces, high-speed serial interface (HSSI) interfaces, Point of Sale (POS) interfaces, fiber data distributed interfaces (FDDIs), and the like. Generally, such interfaces 110 may include physical ports appropriate for communication with appropriate media. In some cases, they may also include an independent processor (such as a dedicated audio or video processor, as is common in the art for high-fidelity A/V hardware interfaces) and, in some instances, volatile and/or non-volatile memory (e.g., RAM).

Although the system shown in FIG. 1 illustrates one specific architecture for a computing device 100 for implementing one or more of the inventions described herein, it is by no means the only device architecture on which at least a portion of the features and techniques described herein may be implemented. For example, architectures having one or any number of processors 103 may be used, and such processors 103 may be present in a single device or distributed among any number of devices. In one embodiment, a single processor 103 handles communications as well as routing computations, while in other embodiments a separate dedicated communications processor may be provided. In various embodiments, several types of features or functionalities may be implemented in a system according to the invention that includes a client device (such as a tablet device or smartphone running client software) and server systems (such as a server system described in more detail below).

Regardless of network device configuration, the system of the present invention may employ one or more memories or memory modules (such as, for example, remote memory block 120 and local memory 101) configured to store data, program instructions for the general-purpose network operations, or other information relating to the functionality of the embodiments described herein (or any combinations of the above). Program instructions may control the execution of or comprise an operating system and/or one or more applications, for example. Memory 120 or memories 101, 120 may also be configured to store data structures, configuration data, encryption data, historical system operations information, or any other specific or generic non-program information described herein.

Because such information and program instructions may be employed to implement one or more systems or methods described herein, at least some network device embodiments may include non-transitory machine-readable storage media, which, for example, may be configured or designed to store program instructions, state information, and the like for performing various operations described herein. Examples of such non-transitory machine-readable storage media include, but are not limited to, magnetic media such as hard disks, floppy disks, and magnetic tape; optical media such as CD-ROM disks; magneto-optical media such as optical disks, and hardware devices that are specially configured to store and perform program instructions, such as read-only memory devices (ROM), flash memory (as is common in mobile devices and integrated systems), solid state drives (SSD) and “hybrid SSD” storage drives that may combine physical components of solid state and hard disk drives in a single hardware device (as are becoming increasingly common in the art with regard to personal computers), memristor memory, random access memory (RAM), and the like. It should be appreciated that such storage means may be integral and non-removable (such as RAM hardware modules that may be soldered onto a motherboard or otherwise integrated into an electronic device), or they may be removable such as swappable flash memory modules (such as “thumb drives” or other removable media designed for rapidly exchanging physical storage devices), “hot-swappable” hard disk drives or solid state drives, removable optical storage discs, or other such removable media, and that such integral and removable storage media may be utilized interchangeably. Examples of program instructions include both object code, such as may be produced by a compiler, machine code, such as may be produced by an assembler or a linker, byte code, such as may be generated by for example a Java™ compiler and may be executed using a Java virtual machine or equivalent, or files containing higher level code that may be executed by the computer using an interpreter (for example, scripts written in Python, Perl, Ruby, Groovy, or any other scripting language).

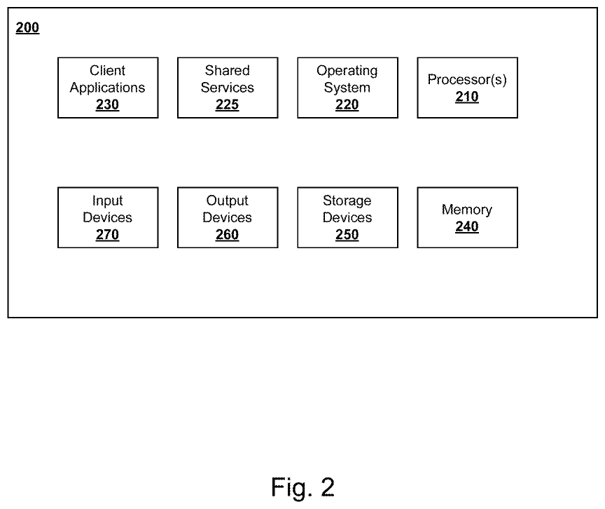

In some embodiments, systems according to the present invention may be implemented on a standalone computing system. Referring now to FIG. 2, there is shown a block diagram depicting a typical exemplary architecture of one or more embodiments or components thereof on a standalone computing system. Computing device 200 includes processors 210 that may run software that carry out one or more functions or applications of embodiments of the invention, such as for example a client application 230. Processors 210 may conduct computing instructions under control of an operating system 220 such as, for example, a version of Microsoft's WINDOWS™ operating system, Apple's Mac OS/X or iOS operating systems, some variety of the Linux operating system, Google's ANDROID™ operating system, or the like. In many cases, one or more shared services 225 may be operable in system 200, and may be useful for providing common services to client applications 230. Services 225 may for example be WINDOWS™ services, user-space common services in a Linux environment, or any other type of common service architecture used with operating system 210. Input devices 270 may be of any type suitable for receiving user input, including for example a keyboard, touchscreen, microphone (for example, for voice input), mouse, touchpad, trackball, or any combination thereof. Output devices 260 may be of any type suitable for providing output to one or more users, whether remote or local to system 200, and may include for example one or more screens for visual output, speakers, printers, or any combination thereof. Memory 240 may be random-access memory having any structure and architecture known in the art, for use by processors 210, for example to run software. Storage devices 250 may be any magnetic, optical, mechanical, memristor, or electrical storage device for storage of data in digital form (such as those described above, referring to FIG. 1). Examples of storage devices 250 include flash memory, magnetic hard drive, CD-ROM, and/or the like.

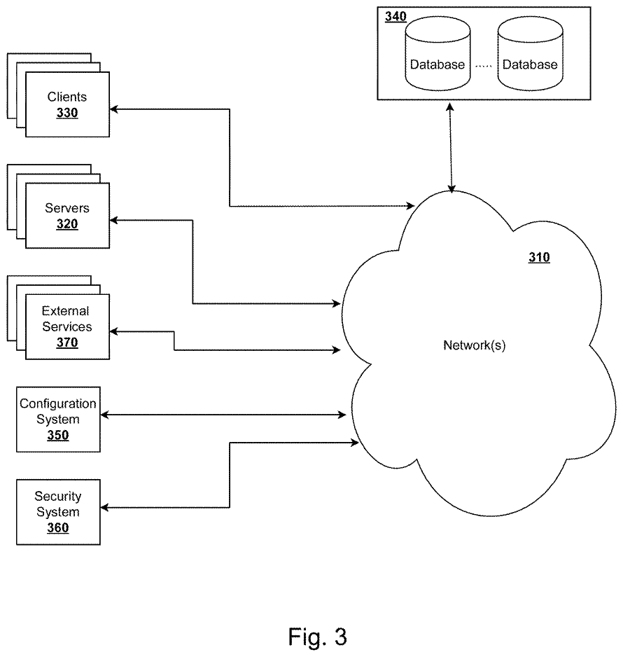

In some embodiments, systems of the present invention may be implemented on a distributed computing network, such as one having any number of clients and/or servers. Referring now to FIG. 3, there is shown a block diagram depicting an exemplary architecture 300 for implementing at least a portion of a system according to an embodiment of the invention on a distributed computing network. According to the embodiment, any number of clients 330 may be provided. Each client 330 may run software for implementing client-side portions of the present invention; clients may comprise a system 200 such as that illustrated in FIG. 2. In addition, any number of servers 320 may be provided for handling requests received from one or more clients 330. Clients 330 and servers 320 may communicate with one another via one or more electronic networks 310, which may be in various embodiments any of the Internet, a wide area network, a mobile telephony network (such as CDMA or GSM cellular networks), a wireless network (such as Wi-Fi, WiMAX, LTE, and so forth), or a local area network (or indeed any network topology known in the art; the invention does not prefer any one network topology over any other). Networks 310 may be implemented using any known network protocols, including for example wired and/or wireless protocols.

In addition, in some embodiments, servers 320 may call external services 370 when needed to obtain additional information, or to refer to additional data concerning a particular call. Communications with external services 370 may take place, for example, via one or more networks 310. In various embodiments, external services 370 may comprise web-enabled services or functionality related to or installed on the hardware device itself. For example, in an embodiment where client applications 230 are implemented on a smartphone or other electronic device, client applications 230 may obtain information stored in a server system 320 in the cloud or on an external service 370 deployed on one or more of a particular enterprises or user's premises.

In some embodiments of the invention, clients 330 or servers 320 (or both) may make use of one or more specialized services or appliances that may be deployed locally or remotely across one or more networks 310. For example, one or more databases 340 may be used or referred to by one or more embodiments of the invention. It should be understood by one having ordinary skill in the art that databases 340 may be arranged in a wide variety of architectures and using a wide variety of data access and manipulation means. For example, in various embodiments one or more databases 340 may comprise a relational database system using a structured query language (SQL), while others may comprise an alternative data storage technology such as those referred to in the art as “NoSQL” (for example, Hadoop Cassandra, Google Big Table, and so forth). In some embodiments, variant database architectures such as column-oriented databases, in-memory databases, clustered databases, distributed databases, or even flat file data repositories may be used according to the invention. It will be appreciated by one having ordinary skill in the art that any combination of known or future database technologies may be used as appropriate unless a specific database technology or a specific arrangement of components is specified for a particular embodiment herein. Moreover, it should be appreciated that the term “database” as used herein may refer to a physical database machine, a cluster of machines acting as a single database system, or a logical database within an overall database management system. Unless a specific meaning is specified for a given use of the term “database,” it should be construed to mean any of these senses of the word, all of which are understood as a plain meaning of the term “database” by those having ordinary skill in the art.

Similarly, most embodiments of the invention may make use of one or more security systems 360 and configuration systems 350. Security and configuration management are common information technology (IT) and web functions, and some amount of each are generally associated with any IT or web systems. It should be understood by one having ordinary skill in the art that any configuration or security subsystems known in the art now or in the future may be used in conjunction with embodiments of the invention without limitation, unless a specific security 360 or configuration system 350 or approach is specifically required by the description of any specific embodiment.

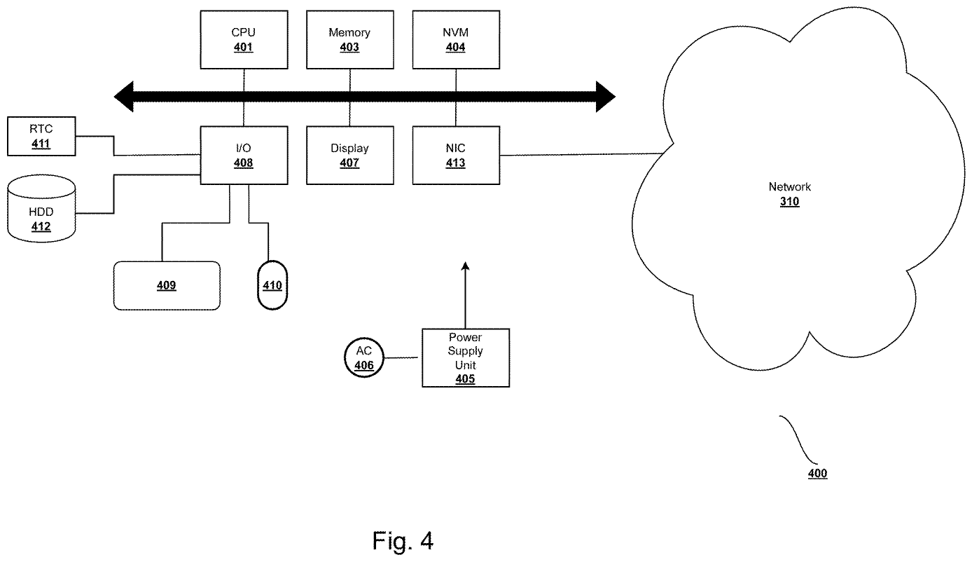

FIG. 4 shows an exemplary overview of a computer system 400 as may be used in any of the various locations throughout the system. It is exemplary of any computer that may execute code to process data. Various modifications and changes may be made to computer system 400 without departing from the broader spirit and scope of the system and method disclosed herein. CPU 401 is connected to bus 402, to which bus is also connected memory 403, nonvolatile memory 404, display 407, I/O unit 408, and network interface card (NIC) 413. I/O unit 408 may, typically, be connected to keyboard 409, pointing device 410, hard disk 412, and real-time clock 411. NIC 413 connects to network 414, which may be the Internet or a local network, which local network may or may not have connections to the Internet. Also shown as part of system 400 is power supply unit 405 connected, in this example, to ac supply 406. Not shown are batteries that could be present, and many other devices and modifications that are well known but are not applicable to the specific novel functions of the current system and method disclosed herein. It should be appreciated that some or all components illustrated may be combined, such as in various integrated applications (for example, Qualcomm or Samsung SOC-based devices), or whenever it may be appropriate to combine multiple capabilities or functions into a single hardware device (for instance, in mobile devices such as smartphones, video game consoles, in-vehicle computer systems such as navigation or multimedia systems in automobiles, or other integrated hardware devices).

In various embodiments, functionality for implementing systems or methods of the present invention may be distributed among any number of client and/or server components. For example, various software modules may be implemented for performing various functions in connection with the present invention, and such modules may be variously implemented to run on server and/or client components.

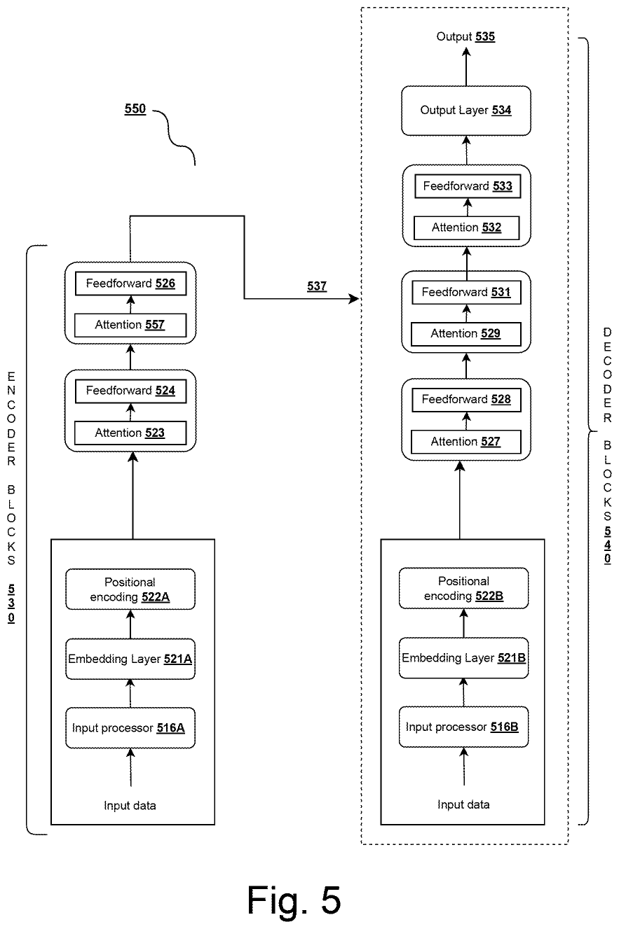

FIG. 5 is an example block diagram of transformer architecture, in accordance with an embodiment of the invention. FIG. 5 shows an encoder-decoder transformer 550 that uses both encoder blocks 530 and decoder blocks 540.

Neural transformers used for performing natural language processing (NLP) may be referred to as Foundation models or Language Models. Text processing-related tasks that can be performed by neural transformers may include but are not limited to, language translation, text summarization, speech synthesis, image processing, and question-answering systems. Transformer architecture depicted in FIG. 5 can be combined with different types of neural networks such as CNN, RNN, LSTM, transformers, etc. to enhance their capabilities and address complex problems.

In an embodiment, the encoder blocks 530 may operate independently and may be referred to as an encoder transformer 530. In an embodiment, the decoder blocks 540 may operate independently and may be referred to as decoder transformer 540.

In an embodiment, encoder transformer 530 (only encoder blocks) includes an input processor 516A for tokenization of an input sequence (herein also referred to as input data) whereby the input sequence may be split into tokens (words or sub-words) and embedded into a dense vector representation. Tokenization is cutting input data into parts (symbols) that can be mapped (embedded) into a vector space. In some embodiments, special tokens may be added to mark the beginning and end of a sequence. In an embodiment, input processor 516A includes a tokenizer with a large dataset of tokens, including all the words, punctuation signs, etc. The tokenization step takes every word, prefix, suffix, and punctuation sign, and sends them to a known token from the library.

Embedding layer 521A converts discrete tokens (such as words, sub word, or characters) into continuous vector representations, (herein also referred to as embeddings), In some embodiment, embedding layer 521A may use pre-trained word embeddings (e.g., Word2Vec, GloVe) or subword embeddings (e.g., Byte Pair Encoding or WordPiece), however, advantageously, embedding layer 521A may also handle various levels of granularity for tokens, including words, sub words, or even characters. Accordingly, embedding layer 521A may receive input as a sequence of tokens. Each token may be represented as an integer or a one-hot encoded vector, indicating its position in a predefined vocabulary. Embedding layer 521A may map each discrete token to a continuous vector in a high-dimensional space. These continuous vector embeddings may capture the semantic meaning and context of the tokens. For instance, tokens with similar meanings should have embeddings that are close in vector space. Embeddings may be learnable parameters of a model whereby, during training, the model may learn to adjust embeddings to minimize a loss function by making them informative about the input data. This means that the embeddings may be updated via backpropagation during the training process. It should be noted that embeddings, from embedding layer 521A, are high-dimensional vectors, often with hundreds of dimensions. This high dimensionality enables the model to capture fine-grained relationships and nuances between tokens in the input data. It also allows the model to learn complex patterns and hierarchies within the data. In some embodiments, the same embedding may be shared between input and output layers to reduce the parameter count of the model and enhance efficiency. Accordingly, sharing embeddings may help maintain consistency between input and output representations.

Positional encoding 522A may provide information about the order of words whereby positional encoding is added to the word embeddings to provide information about the token's position in a sequence to provide a model with information about the position of each token in the input sequence for capturing sequential dependencies in data comprised within the input sequence. Accordingly, the model may process all tokens in the input sequence in parallel. In a preferred embodiment, positional encoding 522A may treat each token independently and inject information about the position of each token. In some embodiments, positional encoding 522 may learn encoding during training and such encoding may be added to the token embeddings in a way that it varies across dimensions and positions. In some embodiments, positional encoding 522A may use sinusoidal encoding by using a combination of sine and cosine functions with different frequencies and phases to ensure that a positional encoding is unique for each position while capturing a relative position of tokens effectively. According to the embodiment, using sinusoidal functions, positional encoding 522A may introduce a sense of periodicity to the embeddings, allowing the model to distinguish tokens at different positions. A choice of frequencies may ensure that tokens with different positions have distinct positional encodings. This may help the model learn dependencies that are based on the order of tokens. Further according to the embodiment, during each forward pass of the model, positional encoding 522A may modify each token's embedding based on its position in the sequence, making it unique and informative with respect to its position. Positional encoding 522A may function in conjunction with self-attention mechanisms within the architecture to attend to different parts of the input sequence based on the content of the tokens and the positional information. This allows the model to give appropriate attention to contextually relevant tokens. Advantageously, positional encoding 522A provides a learnable component whereby during training, the model learns appropriate encoding patterns that may best capture the sequential dependencies in the training data. This means that the model can adapt to sequences of different lengths and patterns. Positional encoding 522A may provide the model with the necessary information to understand the order and relationships between tokens in the input sequence for processing natural language tasks and other sequence-based tasks in deep learning. Input processor 516A works with token embeddings and positional encodings (from positional encoding 522A) combined with parallel processing and self-attention mechanisms for efficient and effective machine translation, text generation, sentiment analysis, and the like.

In an embodiment, each layer of encoder transformer 530 comprises a feed-forward component and an attention component. In an embodiment, the first layer includes attention 523 and feed-forward 524. The second layer includes attention 557 and feed-forward 526.

Attention component may be used for deciding which parts of the input sequence are important for each token/sub-token, especially when decoding long sequences since the encoder is limited to encoding a fixed-size vector. Attention mechanisms gather information about the relevant context of a given token/sub-token and then encode that context into a vector that represents the token/sub-token. It is used to identify the relationships between tokens in the long sequence while ignoring other sub tokens that do not have much bearing on a given prediction.

In an embodiment, feed-forward is a feed-forward neural network. After the self-attention mechanism, the encoded representations pass through a feed-forward neural network (FFNN) in each layer. This FFNN consists of two linear transformations separated by a non-linear activation function, such as the Rectified Linear Unit (ReLU). FFNN helps capture complex patterns and relationships in the encoded representations, enabling the model to learn higher-level features.

In an embodiment, the attention component utilized in encoder transformer 530 layers may be a self-attention mechanism that allows a token to weigh the importance of every other token in the sequence when encoding information. However, a single self-attention mechanism may not be sufficient to capture various types of dependencies within the data, therefore, a multi-head self-attention mechanism addresses this limitation. Accordingly, the multi-head self-attention mechanism applies the self-attention operation multiple times in parallel, with each head (that is, a separate and parallel processing pathway that independently attends to different aspects or patterns within the input sequence) having its own set of learnable parameters (for example, for query, key, and value projections). Each head can focus on different aspects of the input, enabling the model to capture diverse patterns and relationships.

Each encoder layer comprises a feed-forward component whereby after attention, the information passes through a neural network that may perform a transformation to introduce non-linearity into the model as modeled data relationships disclosed herein are non-linear. This transformation allows the model to learn relevant features or representations of the data input. Further, by iteratively stacking multiple encoder layers, transformer architecture can effectively capture complex patterns and dependencies in the input sequence, leading to state-of-the-art performance in various natural language processing tasks such as machine translation, text generation, and sentiment analysis.

Output layer 535 comprises a liner layer and a SoftMax layer. The linear layer is a fully connected neural network that projects the raw scores output by the last layer of the neural network into a logit vector. The SoftMax layer applies the SoftMax function to the logits vector to compute a vector that represents the probability distribution of a list of potential outcomes. In some embodiments, attention scores may be calculated and scaled and then passed through a SoftMax function to obtain the attention weights. These weights may determine how much each token may contribute to the output of the self-attention operation. Tokens that are more relevant to the current token may receive higher attention weights.

In an embodiment, decoder transformer model 540 includes a positional encoding 522B, an embedding layer 521B, and a processor 516B performs the same function as positional encoding 522A, embedding layer 521A, and processor 516A described for encoder transformer 530.

In an embodiment, each layer of decoder transformer model 540 comprises a feed-forward component and an attention component. In an embodiment, the first layer includes attention 527 and feed-forward 528. The second layer includes attention 529 and feed-forward 531. The third layer includes attention 532 and feed-forward 533.

In an embodiment, attention component of decoder layers includes a masked self-attention component. The masked self-attention component allows the neural network to identify certain features or inputs. The inputs to the decoder block are added with positional embeddings 522B. Decoder layers may be configured to predict each token/sub token in the target language one-by-one at each time step conditioned on all previously generated target tokens/sub tokens. The masked self-attention component in each layer masks the output embeddings from future time steps. The feed-forward neural network processes each output embedding separately.

Output layer 534 includes a linear layer and a SoftMax layer. Blocks of decoder transformer model 540 may be capped off with a linear layer that acts as a classifier, and a SoftMax to get the word probabilities Linear layer projects the vector produced by the stack of decoders into a logits vector, and the SoftMax layer then turns the scores of the logits vector into probabilities for each token in the vocabulary which are positive and normalized.

The transformer architectures described above can be used as a model for performing NLP-related functions. A trained transformer architecture is referred to as a Large Language Model (LLM). LLM may be a foundation model that utilizes deep learning in NLP and natural language generation (NLG) tasks. To help them predict the complexity and linkages of language, language models are pre-trained on a vast amount of data. Transformer may be trained using a large dataset of text paired with appropriate labels (e.g., responses in a conversational dataset). Training involves minimizing a loss function (e.g., cross-entropy) between the predicted output and the actual target sequence. Accordingly, the model learns patterns and relationships within the data to enable the model to make accurate predictions, and classifications, or generate desired outputs when presented with new, unseen data. Training begins with the collection of a dataset that consists of input data (features) and corresponding target labels or ground truth values. The dataset may be representative of the problem the methods disclosed herein is intended to solve. The large language model or language model structure, architecture, and parameters may be defined to include neural networks, decision trees, support vector machines, and more, depending on the nature of the task. Training may include the use of a loss function, also known as a cost or objective function, is chosen to measure the difference between the model's predictions and the true labels in the training data. The goal is to minimize this loss, as it quantifies the model's performance. Training may utilize an optimization algorithm to adjust the model's parameters (e.g., weights and biases) during training in a way that minimizes the loss. Optimization algorithms may include stochastic gradient descent (SGD), Adam, and RMSprop. During training, data may be fed through the model in a forward pass to make predictions, a loss is then calculated, and gradients of the loss with respect to the model parameters may be computed in a backward pass. Parameters may be updated using the gradients and the chosen optimization algorithm. The learning rate, which determines the step size of parameter updates, may be adjusted. Training may be performed iteratively for multiple epochs (complete passes through the training data) in order to improve the model's performance with each epoch, gradually reducing the loss. During training, a separate validation dataset may be used to monitor the model's performance on data it hasn't seen before. This helps detect overfitting and guides hyperparameter tuning. After training is complete, the model is evaluated on a test dataset that it has never seen. This provides a final assessment of the model's generalization performance. Based on NLP related task, a transformed model architecture is selected.

In an embodiment for encoder-decoder transformer 550, the processing is performed using multiple layers of encoder transformer 530 and decoder transformer 540. Encoder transformer 530 processes the input data and transforms it into a different representation, which is subsequently decoded by decoder transformer 540 to produce the desired output. The output 537 of the top encoder layer is a set of attention vectors K and V which is used by the multi-head attention layer of the decoder blocks 540. Encoder-decoder transformer 550 may be implemented for tasks where an input sequence needs to be transformed into an output sequence, such as machine translation. The encoder blocks 530 processes the input sequence and compresses the information into a “context vector,” and the decoder blocks 540 then uses this context vector to generate the output

In a transformer using encoder transformer 530, attention is trained on a large unsupervised training dataset of source code and natural language source code summaries. The encoder transformer 530 may be then fine-tuned by a fine-tuning component with a particular supervised training dataset for a particular downstream task to produce a corresponding model.

In a transformer using encoder transformer 530 is suited for classification tasks due to the type of attention used in the encoder. Encoder transformer 530 architecture is often employed in tasks like text classification, sentiment analysis, embedding generation, text generation, language understanding, document classification, and question answering. BERT™ (Bidirectional Encoder Representations from Transformers) is a widely used Encoder-only model. It has been pre-trained on a large corpus of text and can be fine-tuned for specific NLP tasks.

In a transformer using with decoder transformer model 540, is an auto-regressive model that produces an output one element at a time based on the outputs of previous time steps. Code completion is best suited for a decoder transformer model 540 since it is an auto-regressive task that predicts an ordered sequence of tokens where the order depends on the preceding tokens in the sequence. Decoder transformer model 540 uses a masked self-head attention which is best suited for auto-regressive tasks since it is explicitly trained to generate auto-regressively. This type of neural transformer model is best suited for text generation, summarization, text completion, language modeling, text correction, and dialogue systems.

Generating text that is both coherent and contextually consistent is a significant challenge in many NLP tasks, such as text generation, machine translation, and content summarization. Decoder-only transformer architectures have been designed to address this problem. GPT (Generative Pre-trained Transformer) models such as GPT-2 and GPT-3 utilize a Decoder-only structure to generate coherent and contextually relevant text.

In decoder transformer model 540, the multi-head self-attention mechanism in the decoder layers is similar to the one in the encoder layers, but it is masked to prevent the model from attending to future positions, ensuring that the predictions for position “i” can depend only on the known outputs at positions less than “I.” This masking happening internally in the decoder's multi-head self-attention mechanism) is essential to maintain the autoregressive property of the transformer model during training and inference. The autoregressive property ensures that the model generates output tokens one at a time and uses previously generated tokens as context for generating the next word token. Decoder transformer model 540 may often employed for text generation, and larger ones display strong zero-shot inference abilities, performing well across a range of tasks. Zero-shot learning (ZSL) is a machine learning scenario in which an AI model is trained to recognize and categorize objects or concepts without having seen any examples of those categories or concepts beforehand. They can perform tasks with limited or no task-specific training data by leveraging the knowledge acquired during pre-training. This is particularly useful in scenarios where labeled data is scarce or when adapting. Further, decoder-based models, particularly those with a large number of layers and attention heads, can capture long-range dependencies in the generated text. They can maintain coherence and consistency over longer sequences, which is important for tasks that require generating longer passages of text. Notable examples of decoder-based autoregressive models are GPT (Generative Pre-trained Transformer), Megatron-LM Transformer-XL, CTRL (Conditional Transformer Language Model).

In some embodiments, decoder transformer 540 may offer the ability to control the generated text by conditioning on specific prompts, attributes, or styles. By providing appropriate prompts or control codes, the model may be guided to generate text with desired properties, such as sentiment, topic, or writing style. This controllability is valuable for applications like content creation, personalization, and dialogue systems.

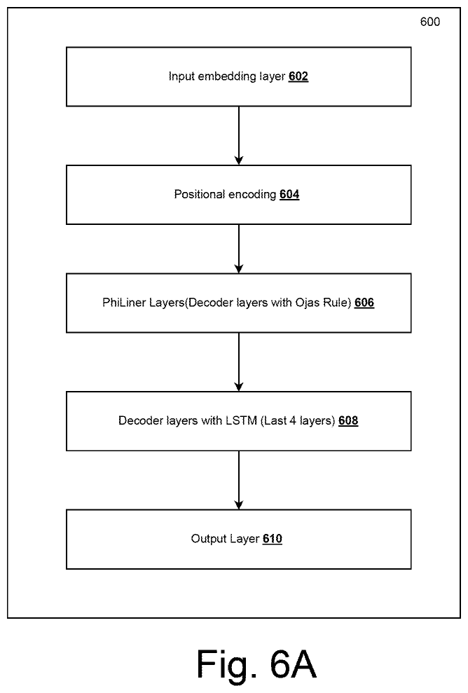

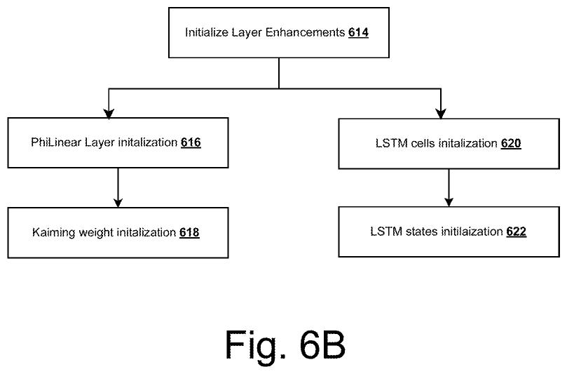

FIG. 6A is an example block diagram of an enhanced transformer model 600, in accordance with an embodiment of the invention. FIG. 6A shows a hierarchical structure of the model, flowing from input to output through specialized layers.

In an embodiment, an input embedding layer 602 may transforms input tokens into continuous vector representations suitable for processing by the neural network.

In an embodiment, positional encoding 604 may add information about the relative or absolute position of tokens in the sequence to enable the model to understand token order.

In an embodiment, PhiLinear Layers (Decoder Layers with Ojas Rule) 606 may be custom decoder layers incorporating the Ojas rule for enhanced learning of principal components, enabling better pattern recognition and feature extraction. The Ojas rule is integrated into transformer model by creating a custom linear layer (PhiLinear) that incorporates the rule into its weight update mechanism. The Ojas rule helps the neural network focus on the most important patterns in the data, functioning as an implicit principal component analyzer.

Δwᵢⱼ=η(y_{i.}·xⱼ−yᵢ²·wᵢⱼ)

As used herein, “principal components” refers to directions in a feature space corresponding to relatively higher variance in layer outputs, as approximated through iterative weight updates using the Oja learning rule. Such components are not required to correspond to exact eigenvectors derived from explicit covariance matrix decomposition but instead represent learned feature directions that capture dominant patterns in the input data during training.

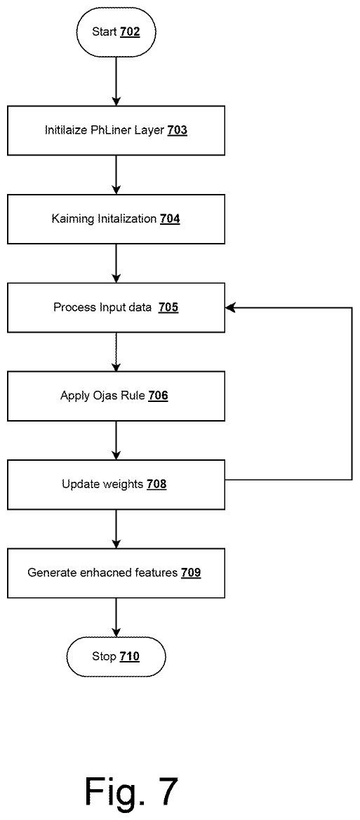

As used herein, terms such as “enhanced feature representation,” “important patterns,” or similar expressions refer to feature representations that reflect relatively higher variance, stronger statistical significance, or increased contribution to model output as determined through learned weight magnitudes, attention weights, or activation values within the network. Such terms do not require absolute or fixed thresholds but instead refer to relative differences learned during model training.

Where, Δwᵢⱼ is the weight update, η is the learning rate, y_{i.} is the output of neuron i, ·xⱼ is the input from neuron j, and wᵢⱼ is the current weight. More details related to the implementation and operation of PhiLinear l layers are discussed in FIG. 7.

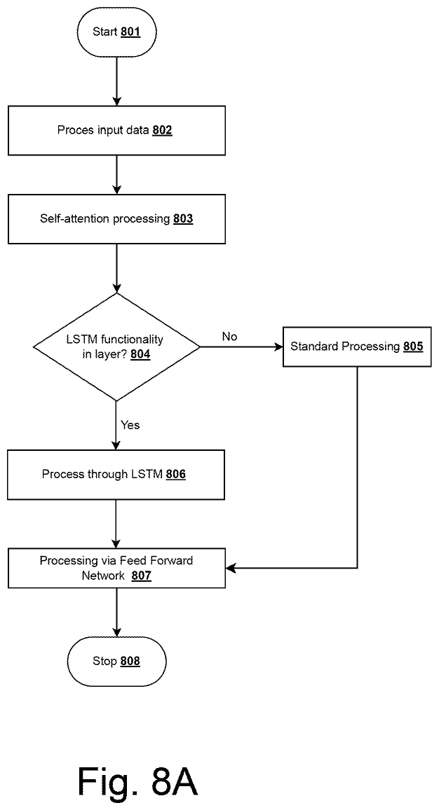

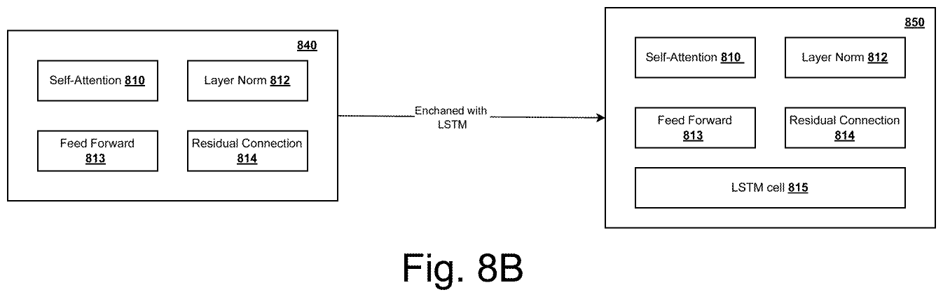

In an embodiment, decoder Layers with Long Short-Term Memory (LSTM) 608 may be final four decoder layers that integrate Long Short-Term Memory (LSTM) cells to enhance sequential information processing. This placement was chosen to enhance the model's sequential understanding capabilities closer to the output, where contextualized representations benefit most from explicit sequential processing. These layers combine the transformer's 600 contextual learning capabilities with LSTM's sequential memory for improved temporal pattern recognition. More details related to the implementation and operation of decoder Layers with LSTM are discussed in FIGS. 8A and 8B.

In some embodiments, LSTM cells are incorporated into a subset of decoder layers, such as a final set of layers, although the specific selection of layers may vary based on model configuration, depth, or application requirements.

In an embodiment, output layer 610 may be the final layer that transforms the model's internal representations into the desired output format.

FIG. 6B is a flowchart depicting the initialization process for the enhanced layers in the transformer model 600, in accordance with an embodiment of the invention.

Step 614 may be the starting point for setting up the specialized components of the model. In an embodiment, custom initialization functions may be called during the model construction phase. The initialization may be triggered during model instantiation. At step 616, the custom linear layers that incorporate the Ojas rule are initialized. At step 618, a Kaiming weight initialization technique is implemented to provide a stable starting point for the learning process. This helps prevent issues like vanishing or exploding gradients. At step 620, LSTM cells may be set up in the designated decoder layers. Each LSTM cell may include an input gate (to controls what new information is stored in the cell state), a forget gate (to decides what information to discard from the cell state) , an output gate (to controls what parts of the cell state to output), a cell state (the long-term memory component that runs through the entire sequence, and a hidden state(the short-term memory component that is updated at each step). Standard transformer layers are used for the initial layers (layers 1-8 in the example). LSTM-enhanced layers are used for the final layers (layers 9-12 in the example). This targeted approach focuses the sequential enhancement where it's most beneficial. At step 622, an LSTM initialization is performed. Two types of states are initialized: Cell state (c) which is the long-term memory component and hidden State which is the working memory/output component. Initial states are typically set to zeros. States can be initialized at the beginning of processing or passed from previous steps.

FIG. 7 is a flowchart depicting a method for generating principal components of the input data, in accordance with an embodiment of the invention. The method begins at step 702 and ends at step 710. At step 703, the method begins with the initialization of a custom PhiLinear layer designed specifically to incorporate the Ojas rule. During model initialization, this layer replaces standard linear layers in the transformer architecture. This custom layer serves as the foundation for integrating biologically-inspired learning principles into transformer, bringing Hebbian-like properties to deep learning. The layer maintains compatibility with the rest of the transformer architecture, ensuring seamless integration without requiring wholesale changes to the model 600 structure. This modification allows the model 600 to focus more effectively on principal components in the data while maintaining the transformer's parallel processing capabilities.

At step 704, once the PhiLinear layer is created, weight initialization may perform using the Kaiming (also known as He) initialization method. This initialization technique, introduced by He et al., sets initial weight values based on the number of input and output connections to prevent exploding or vanishing gradients. Inside “reset_parameters” method of the PhiLinear class, weights are initialized using a formula that scales the random values by the square root of the fan-in (number of input features). This careful initialization ensures the model starts learning from an optimal position, preventing wild fluctuations during early training phases. Without proper initialization, the Ojas rule's effectiveness would be compromised as it relies on appropriately scaled initial weights to perform its principal component analysis effectively. The Kaiming initialization provides numerical stability that complements the Ojas rule's self-normalizing properties. Kaiming Initialization (704): Application of Kaiming initialization method to set optimal starting weights for stable learning.

At step 705, during the forward pass, input data flows through the network and PhiLinear layer. The input tensor passes through a matrix multiplication with the weights (plus bias if applicable), similar to a standard linear layer. This operation is handled by the forward method of the custom autograd function that's integrated into the PhiLinear layer. The forward computation remains essentially unchanged from a standard linear layer to maintain computational efficiency and compatibility with other transformer components.

The custom autograd function saves important tensors and context information that will be needed for the specialized backward pass. These saved tensors include the input values and output results, which are crucial for applying the Ojas rule during backpropagation. This step prepares the groundwork for the distinctive weight update mechanism that follows while ensuring the forward computation remains efficient.

At step 706, during backpropagation in the backward method of the custom autograd. function, Ojas rule is applied to calculate weight updates according to the formula

Δw=η(y.x−y².w)

where y is the output, x is the input, w represents the current weights, and η is the learning rate. This formula implements a self-normalizing Principal Component Analysis (PCA) mechanism that helps the neural network focus on the most important patterns in the data. Unlike standard backpropagation which solely minimizes loss, the Ojas rule adjusts weights to maximize the variance of the output (capturing important features) while simultaneously normalizing the weight vectors (preventing runaway values). This biologically-inspired approach enhances the model's feature extraction capabilities by focusing computational resources on principal components rather than noise.

In some embodiments, the PhiLinear layer implements a modified linear transformation that is compatible with standard neural network training workflows. During a forward pass, the PhiLinear layer computes an output according to:

y=Wx+b

where W is a weight matrix, x is an input vector or tensor, and b is a bias term.

During training, weight updates for W incorporate a learning component based on the Oja rule. In particular, an update term is computed as:

ΔWₒⱼₐ=η(yx^{T}−y²W)

where η is a learning rate parameter, y is the output of the layer, and x is the corresponding input. This update term promotes alignment of the weight vectors with directions of high variance in the input data while maintaining normalized weight magnitudes.

In an embodiment, the PhiLinear layer is implemented within an automatic differentiation framework such that the forward pass remains a standard linear transformation, while the backward pass includes the computation of the Oja-based update term. The Oja-based update term may be combined with gradient-based updates derived from a loss function, such that the overall weight update reflects both error-driven learning and variance-based feature extraction.

In some implementations, the Oja-based update is applied on a per-sample or per-batch basis and may be scaled or weighted relative to gradient-based updates. This hybrid update mechanism enables the model to retain compatibility with conventional optimization techniques while enhancing the ability of the network to emphasize principal feature directions in the input data.

At step 708, once the Ojas rule calculates the appropriate weight adjustments, PyTorch's optimizer uses these gradients to update the actual weights of the PhiLinear layer. This modification to the standard optimization process enhances the model's ability to extract principal components from the input data. The weight updates now incorporate both traditional error correction (from standard backpropagation) and principal component emphasis (from the Ojas rule). This hybrid approach allows the model to learn representations that better capture the underlying structure of the data.

In some embodiments, the training process incorporating the PhiLinear layer may be expressed procedurally as follows: For each training iteration, input data is processed through the network to generate an output y from the PhiLinear layer based on input x. A loss function is computed based on the output and corresponding target data. During backpropagation, gradient-based updates are computed, and an additional update term based on the Oja rule is calculated according to ΔWₒⱼₐ=η(yx^{T}−y²W). The weight matrix W is then updated based on a combination of the gradient-based update and the Oja-based update.

At step 709, PhiLinear layer produce outputs with enhanced feature representation using the updated weights (emphasize principal components). These improved features propagate through the network, allowing higher layers to work with more meaningful representations. The enhanced feature extraction benefits the entire model, particularly improving the attention mechanism's ability to focus on relevant relationships in the data. The implementation of Ojas rule using PhiLinear layers helps the model 600 to zero in on the most important patterns in the data, like recognizing the main features in a picture, making it smarter and better at understanding what's truly important.

In some embodiments, the incorporation of the Oja-based update term during training biases the learned weight representations toward directions of higher variance in the input data. This results in improved feature selectivity and more stable weight magnitudes compared to gradient-only optimization. As a result, the model may exhibit improved generalization performance and reduced sensitivity to noise or overfitting, particularly in scenarios involving high-dimensional or sparse input data.

FIG. 8A is a flowchart depicting the processing of inputs through the LSTM enhanced transformer layer, in accordance with an embodiment of the invention. The method begins at step 801 and ends at step 808. Step 801 indicates the beginning of the layer processing operation, which is triggered when input data reaches a decoder layer in the transformer 600 stack. At this point, the system has already received embedded input with positional encoding. At step 802, input data is processed. The processing of input data may include layer normalization of the incoming tensor, preparation of residual connection for later addition, input shape verification and any necessary reshaping operations, and application of dropout for regularization (typically 0.1 dropout rate). This step ensures the data is properly formatted before specialized processing At step 803, self-attention mechanism processing in initiated. Self-attention mechanism is applied to capture relationships between different positions in the input sequence. A linear projection of input is created into query, key, and value representations. Attention scores may be computed by matrix multiplication of queries and keys. This mechanism enables the model to focus on relevant parts of the input sequence. At step 804, model 600 may determine whether the current layer includes LSTM functionality. In some embodiments, this determination is based on a configuration parameter, layer index, or predefined architecture specification. When its is determined that the current layer does not have LSTM cell, then at step 804 standard transformer processing is performed. The self-attention output may be directly forwarded to the next layer. This path uses the efficient parallel processing capability of transformers

When it is determined that the current layer has LSTM cell, then at step 806, the input is processed using the LSTM cell to capture sequential dependencies. Enhanced processing path includes reshaping the self-attention output to fit LSTM input requirements, retrieving or initializing hidden states (h) and cell states (c) for the LSTM, processing through LSTM gates (input, forget, output gates and cell memory). The forget gate determines what information to discard from cell state and the input gate determines what new information to store in cell state. The output gate determines what parts of the cell state to output. The hidden states and cell states are updated and stored for subsequent processing. This integration enhances the model's ability to capture sequential dependencies

At step 807, processing continues through the feed-forward neural network that follows either the LSTM or standard processing path.

This architecture uniquely combines the parallelizable nature of transformer self-attention with the sequential processing capabilities of LSTM cells, selectively applied to optimize both performance and computational efficiency. The LSTM integration is specifically targeted at the later layers where refined sequential understanding is most beneficial for the model's 600 output quality.

FIG. 8B is a side-by-side comparison of the standard transformer layer architecture 840 and the LSTM-enhanced version 850, in accordance with an embodiment of the invention.

In standard transformer layer architecture 840, a self-attention 810 mechanism weighs the importance of different positions in the input sequence. This mechanism uses queries, keys, and values to determine contextual relationships between elements, regardless of their distance within the sequence.

Layer normalizer 812 performs normalization that helps stabilize the learning process by standardizing the outputs to have zero mean and unit variance, controlling the layer's activation distribution.

A feed forward network 813 that processes each position separately, typically consisting of two linear transformations with a Rectified Linear Unit (ReLU)activation in between, allowing the model to incorporate non-linearity.

Residual connection 814 adds the input to the output of the self-attention and feed-forward sublayers, helping with gradient flow during backpropagation and enabling training of deeper networks.

In standard transformer layer architecture 840, in addition to the components (Self-attention, layer norm, feed forward, residual connection) of the standard transformer layer architecture 840, an LSTM Cell 815 is present. Long Short-Term Memory unit that enhances the model's ability to capture sequential patterns and maintain information over longer sequences.

LSTM 815 cell incorporates specialized gating mechanisms-including input, forget, and output gates-that control information flow through the cell state. This addition enables the transformer to combine the parallel processing and long-range dependency benefits of self-attention with the sequential memory capabilities of recurrent architectures.

LSTM cell 815 is strategically placed to process the output of the self-attention mechanism after layer normalization but before the feed-forward network. This placement allows the model to maintain memory states across positions in the sequence, particularly beneficial in the last four layers of the decoder where refined contextual representations benefit most from sequential processing. The cell includes hidden states (h) and cell states (c) that are initialized at the beginning of processing and carried forward through the sequence, providing explicit temporal memory that complements the transformer's position-based processing.

During forward propagation, the output from self-attention 810 and layer normalization 812 is reshaped to match the LSTM input requirements before being processed by LSTM cell 815. LSTM processes this input sequentially, updating its internal states based on both current inputs and past context. The outputs of LSTM cell 815 may be then passed to the feed-forward network 813, with residual connection 814 maintaining gradient flow. This hybrid approach combines the strengths of both architectures-the transformer's ability to process all positions simultaneously and capture long-range dependencies through attention, and the LSTM's ability to model sequential information and maintain explicit memory of previous tokens.

Step 808 indicates the data processing operation is passed to the next decoder layer in the transformer 600 stack.

The skilled person will be aware of a range of possible modifications of the various embodiments described above. Accordingly, the present invention is defined by the claims and their equivalents.

What is claimed is:

1. A system for processing sequential data, comprising one or more processors, a memory, and a plurality of programming instructions stored in the memory that, when executed by the one or more processors, cause the one or more processors to:
process input data using a transformer-based neural network comprising a plurality of decoder layers including self-attention operations and feed-forward neural network operations;
replace at least one linear transformation within at least one of the decoder layers with a modified linear transformation layer;
during training, update weights of the modified linear transformation layer using a variance-based learning rule based on input activations and corresponding layer outputs, wherein the variance-based learning rule is combined with gradient-based updates derived from a loss function; and a
apply long short-term memory (LSTM) processing within a subset of the decoder layers after the self-attention operations and before the feed-forward neural network operations.

2. The system of claim 1, wherein the subset of decoder layers that include LSTM processing corresponds to a final portion of the decoder layers in the transformer-based neural network.

3. The system of claim 1, wherein the subset of decoder layers that include LSTM processing is determined based on at least one of a layer index, a configuration parameter, or a predefined architecture specification.

4. The system of claim 1, wherein the modified linear transformation layer replaces a linear transformation within a feed-forward neural network of at least one decoder layer.

5. The system of claim 1, wherein the modified linear transformation layer is configured to generate feature representations aligned with higher-variance directions in the input data.

6. The system of claim 1, wherein the system is configured to process the input data through a forward pass using standard transformer operations and apply the variance-based learning rule during a backward pass.

7. The system of claim 1, wherein the transformer-based neural network includes positional encoding and embedding layers configured to generate input representations for the decoder layers.

8. The system of claim 1, wherein the variance-based learning rule is applied to a subset of weights within the modified linear transformation layer based on input-dependent activation values.

9. The system of claim 1, wherein the LSTM processing includes maintaining a hidden state and a cell state that are updated across sequential positions of the input data.

10. The system of claim 1, wherein the modified linear transformation layer and the LSTM processing are applied within the same decoder layer.

11. A method for processing sequential data, comprising: processing input data using a transformer-based neural network comprising a plurality of decoder layers including self-attention operations and feed-forward neural network operations;
replacing at least one linear transformation within at least one of the decoder layers with a modified linear transformation layer;
during training, updating weights of the modified linear transformation layer using a variance-based learning rule based on input activations and corresponding layer outputs, wherein the variance-based learning rule is combined with gradient-based updates derived from a loss function; and
applying long short-term memory (LSTM) processing within a subset of the decoder layers after the self-attention operations and before the feed-forward neural network operations.

12. The method of claim 11, wherein the subset of decoder layers that include LSTM processing corresponds to a final portion of the decoder layers in the transformer-based neural network.

13. The method of claim 11, wherein the subset of decoder layers that include LSTM processing is determined based on at least one of a layer index, a configuration parameter, or a predefined architecture specification.

14. The method of claim 11, wherein the modified linear transformation layer replaces a linear transformation within a feed-forward neural network of at least one decoder layer.

15. The method of claim 11, wherein the modified linear transformation layer generates feature representations aligned with higher-variance directions in the input data.

16. The method of claim 11, further comprising processing the input data through a forward pass using standard transformer operations and applying the variance-based learning rule during a backward pass.

17. The method of claim 11, wherein the transformer-based neural network includes positional encoding and embedding layers configured to generate input representations for the decoder layers.

18. The method of claim 11, wherein the variance-based learning rule is applied to a subset of weights within the modified linear transformation layer based on input-dependent activation values.

19. The method of claim 11, wherein the LSTM processing includes maintaining a hidden state and a cell state that are updated across sequential positions of the input data.

20. The method of claim 11, wherein the modified linear transformation layer and the LSTM processing are applied within the same decoder layer.
